(19) United States
(12) Patent Application Publication
(10) Pub. No.: US 2023/0111535 A1
(43) Pub. Date: Apr. 13, 2023

(54) Battery for a Motor Vehicle

(71) Applicant: Bayerische Motoren Werke Aktiengesellschaft, Muenchen (DE)

(72) Inventors: Erdem ALI, Muenchen (DE); Simon HAERLE, Muenchen (DE); Andre HECKERT, Muenchen (DE); Tuncay IDIKURT, Muenchen (DE); Maximilian KRAEMER, Muenchen (DE); Alexander MUCK, Muenchen (DE)

(21) Appl. No.: 17/792,180

(22) PCT Filed: Jan. 13, 2021
(86) PCT No.: PCT/EP2021/050504

§ 371 Date: Jul. 12, 2022

(30) Foreign Application Priority Data
Feb. 14, 2020 (DE) 10 2020 103 954.9

(51) Int. Cl. H01M 10/04; H01M 50/204; H01M 50/262; H01M 10/613; H01M 10/6556; H01M 10/625

(52) U.S. Cl. CPC H01M 10/0481; H01M 10/613; H01M 10/625; H01M 10/6556; H01M 50/204; H01M 50/262; H01M 2220/20

(57) ABSTRACT

A battery for a motor vehicle includes a first stack of battery cells, a pressure being applied to the battery cells in the stack direction of the battery cells in the first stack, and a second stack of battery cells, the second stack being arranged adjacently to the first stack in the stack direction. A pressure is also applied to the battery cells of the second stack in the stack direction. A pressure plate, to which the pressure is applied in the stack direction, is arranged in an intermediate space formed between the first stack and the second stack, and the pressure plate is made of plastic at least in the contact regions where the pressure plate contacts the first stack and the second stack.

### BACKGROUND AND SUMMARY OF THE INVENTION

The invention relates to a battery for a motor vehicle, with a first stack of battery cells, in which pressure is applied to the battery cells in a stack direction of the battery cells. A second stack of battery cells is arranged adjacent to the first stack in the stack direction. Pressure is also applied to the battery cells of the second stack in the stack direction.

If a battery is used as an electrical energy storage device in a motor vehicle which takes the form of an electric vehicle or a hybrid vehicle, a plurality of battery cells of the battery are usually connected to one another in an electrically conductive fashion. Multiple stacks of battery cells can also here adjoin one another in a stack direction of the battery cells or be arranged next to one another.

DE 10 2012 219 782 A1 describes, for example, an arrangement of multiple stacks of battery cells, in which the stacks adjoin one another in a stack direction of the battery cells. The battery cells of each stack are here accommodated in a box-shaped housing in which pressure is applied to the battery cells. Each housing comprises two opposite front walls and two side walls screwed or welded to the front walls. A frame, which presses together or compresses the battery cells of each stack with a pretensioning force, is consequently supplied by the housing.

In the case of a battery for a motor vehicle, it can moreover be provided to supply each battery module with a plurality of prismatic battery cells. The battery module can here have a module frame which has two end plates situated opposite each other in the stack direction of the battery cells and tie rods connecting the end plates to each other. The end plates thus act as pressure plates which apply pressure to the battery cells in the stack direction and press them against one another in the stack direction. Such a module frame can be formed from metal components, wherein in particular aluminum and/or steel can be used as metals.

Arranging a plurality of battery cells in a module frame means that fewer such end plates or pressure plates and fewer tie rods need to be used than in the case of a design of the battery with more battery modules which each have fewer battery cells. Accordingly, when battery modules with a large number of battery cells are used, more available structural space can be used for the battery cells or can be taken up by the battery cells. This is advantageous with regard to the amount of electrical energy which can be supplied by the battery.

In particular in the case of relatively large battery modules, it can be provided to arrange, between two stacks of battery cells, a pressure plate, i.e. a plate-like element, to which pressure is applied in the same way as the battery cells clamped inside the module frame. Such pressure plates can be used to fix or arrange further components of the battery on the battery module.

It can be provided to form such a pressure plate as an aluminum profile part which is produced by extrusion. This makes it possible to connect the tie rods of the module frame to the pressure plate, for example by welding. However, it is relatively complex to introduce a thread into such a pressure plate formed from aluminum. This is because the pressure plate needs to be machined subsequently in order to do this.

In addition, forming the pressure plate from an electrically conductive metal such as aluminum means that plastic insulation elements may need to be provided in order to ensure sufficiently large clearances or creepage distances. The provision of such plastic insulation elements is also associated with a corresponding complexity in the production of the battery.

Furthermore, the choice of aluminum for the material used, the machining of the pressure plate, and also the provision of the insulation elements make the pressure plate which is arranged between two stacks of battery cells an expensive component of the battery.

The object of the invention is to provide a battery of the type mentioned at the beginning which is particularly simple to manufacture.

This object is achieved according to the claimed invention.

A battery according to an embodiment of the invention comprises a first stack of battery cells. In the first stack, pressure is applied to the battery cells in a stack direction of the battery cells. The battery comprises a second stack of battery cells which is arranged next to the first stack in the stack direction. Pressure is also applied to the battery cells of the second stack in the stack direction. A pressure plate, to which pressure is applied in the stack direction, is arranged in an intermediate space formed between the first stack and the second stack. The pressure plate is formed from plastic, at least in the respective bearing regions in which the pressure plate is in contact with the first stack and with the second stack. The pressure plate can consequently be supplied particularly simply and with minimal effort. This is conducive to simple manufacturing of the battery. Furthermore, plastic is more favorable as a material than, for example, aluminum.

In addition, the pressure plate, which is formed from plastic in at least some regions and is a plate-like or cuboid component, different from the battery cells, of the battery, can be manufactured particularly quickly. This too is beneficial for particularly simple manufacturing of the battery.

Furthermore, connection points for attaching further components of the battery to the pressure plate can be supplied or integrated into the pressure plate particularly simply, quickly, and with minimal effort by virtue of the pressure plate being manufactured at least partially from plastic. This can occur or be achieved directly during the manufacture of the pressure plate.

The pressure plate preferably has at least one passage opening for routing at least one coolant line of a cooling device of the battery through the pressure plate. In other words, in this embodiment, the at least one coolant line can therefore be routed through the at least one passage opening formed in the pressure plate. Because the at least one passage opening is provided in the pressure plate, the coolant line routed through the passage opening is arranged in such a way that it is well protected.

If therefore the motor vehicle equipped with the battery, for example, strikes an obstacle, the coolant line is not situated in the load path of a load exerted on the battery. As a result, it can be ensured to a particularly great extent that, in the event of force being applied to the battery as a result, for example, of an accident, the at least one coolant line is not damaged and hence no coolant escapes from the coolant line. This protection of the at least one coolant line by the pressure plate exists in particular when the pressure plate is arranged essentially centrally in a battery module, comprising the two stacks, of the battery.

The at least one coolant line can be designed to convey a coolant and/or a refrigerant. Accordingly, the at least one coolant line can also generally be referred to as a cooling line. Both a coolant and a refrigerant can namely be used in the cooling device of the battery to cool the battery cells and be conveyed via the at least one coolant line.

In particular, the pressure plate can have a first passage opening for a coolant line in the form of a coolant inflow and a second passage opening for a coolant line in the form of a coolant outflow. The coolant can, for example, be introduced into a cooling plate of the cooling device and discharged again from the cooling plate on which the battery cells of the two stacks are arranged via such coolant lines. Via the coolant lines which are routed through the passage openings of the pressure plate, the coolant can, by way of further coolant lines, be fed to a radiator of the motor vehicle and fed back to the cooling plate after it has passed through the radiator.

The further coolant lines which lead to the radiator of the motor vehicle and lead away from the radiator can here in particular run parallel to the longitudinal axis of the motor vehicle and be arranged essentially centrally in the direction of the transverse axis of the motor vehicle. This is conducive to protecting the further coolant lines from any damage as well. In addition, there is also structural space in a motor vehicle in the form of an electric vehicle in the region of the center of the vehicle in the longitudinal direction of the motor vehicle for accommodating the coolant lines which lead to the radiator and lead away from the radiator.

It can be provided that the whole pressure plate is formed from plastic. This makes it possible to manufacture the pressure plate with particularly minimal effort.

At least one base body, having the bearing regions, of the pressure plate is therefore preferably formed from plastic. A relatively solid component, in the form of the pressure plate, which can also withstand well the pressure exerted on the battery cells, can thus be supplied particularly simply with minimal effort and cost-effectively.

It can be provided that at least one insert formed from metal is introduced into the base body. At least one metal component of the battery can be fixed to a surface of the insert by welding. By providing such a metal insert which is embedded in the base body of the pressure plate, for example, components such as a device for electrically contacting the individual battery cells, which is also referred to as a cell contact system, and/or an electrical connection line for electrically connecting battery modules of the battery to one another, can be fixed to the at least one insert simply and with minimal effort by welding.

The pressure plate preferably has a first plate part and a second plate part, wherein the plate parts form the pressure plate when coupled to each other. A complex shape can thus also be obtained for the pressure plate particularly simply. In addition, supplying the pressure plate in the form of two plate parts in this way is advantageous with regard to cost-effective manufacture of the plate parts by plastic injection molding.

In particular, the two plate parts can therefore be formed as injection-molded parts. During the injection molding, a sprue point can namely be formed very simply on a side, opposite the bearing region, of the respective plate part. The respective plate part can consequently be removed from an injection mold particularly simply, wherein the direction of removal runs perpendicular to the bearing region. This in turn means that the bearing region can be formed so that it is very flat and is oriented in the intermediate space perpendicular to the stack direction. This is advantageous for a uniform application of pressure to the pressure plate.

The pressure plate can be supplied from the two plate parts with particularly minimal effort if the two plate parts are formed with the same structure. This is because there is then no need to supply different tools to manufacture the respective plate part in an injection-molding process.

The plate parts preferably have mutually corresponding positive-locking elements. The positive-locking elements engage with one another when the plate parts are coupled to each other. It is thus possible to mechanically couple the two plate parts particularly simply in order to supply the pressure plate.

The two bearing regions are preferably formed so that they are flat and are oriented perpendicular to the stack direction. The occurrence of pressure peaks within the pressure plate can consequently be prevented particularly simply and to a great extent.

The pressure plate preferably has at least one threaded hole. A threaded bolt can be screwed into the threaded hole in order to fix at least one retaining device of the battery to the pressure plate. Such a threaded hole can also be formed particularly simply and with minimal effort directly when the pressure plate is produced in an injection-molding process. In addition, the possibility of fixing a particularly wide range of further components of the battery to the pressure plate is thus created.

The first stack and the second stack are preferably components of a battery module of the battery. The battery module here comprises a module frame which encloses the two stacks of the battery module and to which pressure is applied. Such a module frame can be supplied by frontal end plates and the tie rods or side walls connecting the frontal end plates and frontal pressure plates to each other.

If the module frame comprises the two frontal pressure plates or end plates arranged at opposite ends of the two stacks, the pressure plate arranged in the intermediate space between the two stacks can thus also be referred to as an intermediate pressure plate.

Such a battery module having the module frame ensures that the pressure, which prevents to a particularly great extent the bulging of walls of housings of the individual battery cells when the latter are operating, is applied to the battery cells arranged in the respective stacks. This is advantageous for the operation of the battery cells with regard to the supply of electrical energy by the battery cells.

The battery preferably comprises a plurality of battery modules which are connected to one another in an electrically conductive fashion. In this way, a relatively high voltage and/or a relatively high amperage, in particular when the battery discharges current, can be supplied.

This is in particular advantageous when the battery takes the form of a high-voltage battery or high-voltage storage device which supplies electrical energy for a drive device, for example in the form of an electric motor of the motor vehicle. Such a high-voltage storage device has a rated voltage of more than 60 volts and in particular up to several 100 volts.

Further features of the invention can be found in the claims, the drawings, and the description of the drawings. The features and combinations of features mentioned in the description above, and the features and combinations of features mentioned in the description of the drawings below and/or shown individually in the drawings can be used not only in the respective stated description but also in other combinations or individually.

The invention will now be explained in detail with the aid of an exemplary embodiment and with reference to the drawings.

### BRIEF DESCRIPTION OF THE DRAWINGS

FIG. 1 shows a schematic view from above of a battery module, provided for a battery of a motor vehicle, with two stacks of battery cells and with a pressure plate or intermediate pressure plate arranged centrally between the two stacks.

FIG. 2 shows schematically the arrangement of the battery module according to FIG. 1 on a cooling plate, wherein two coolant lines of a cooling device of the battery can pass through passage openings which are formed in the pressure plate.

FIG. 3 shows schematically a first variant of the pressure plate according to FIG. 1 in a perspective view.

FIG. 4 shows a plate part of a further variant of the pressure plate according to FIG. 1, which can be supplied by coupling two such plate parts to each other.

FIG. 5 shows the screwing of a retaining device for a coolant line of the battery to the pressure plate.

FIG. 6 shows, in a highly schematic form, a motor vehicle with the battery which has a plurality of the battery cells shown in FIG. 1.

### DETAILED DESCRIPTION OF THE DRAWINGS

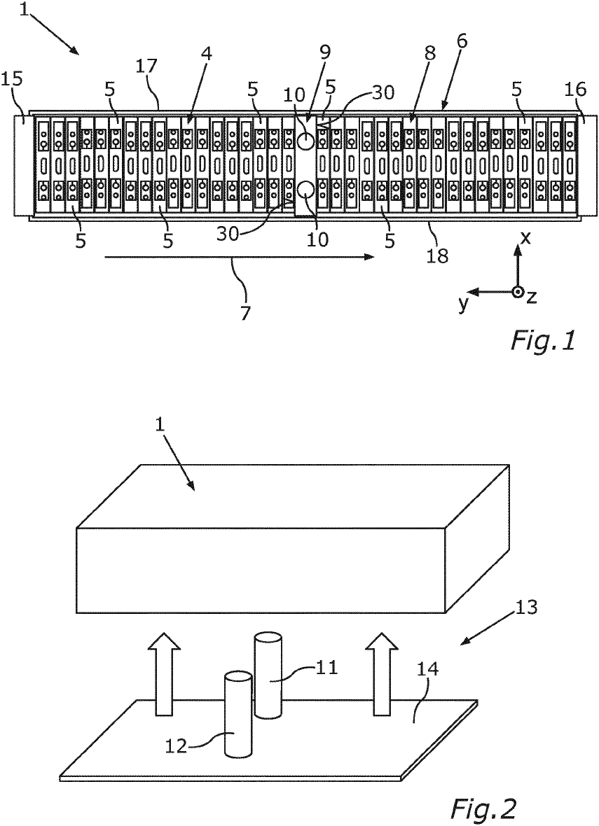

A schematic view from above of a battery module 1 for a battery 2 of a motor vehicle 3 shown in FIG. 6 is illustrated in FIG. 1. The battery module 1 comprises a first stack 4 of a plurality of battery cells 5, only one of which has been provided with a reference numeral in FIG. 1 for the sake of clarity. The battery cells 5 of the first stack 4 are arranged inside a module frame 6 of the battery module 1. The module frame 6 ensures that pressure is applied to the battery cells 5 in the first stack 4 in a stack direction 7 which is illustrated in FIG. 1 by an arrow.

The battery module 1 comprises a second stack 8 of a plurality of battery cells 5 which, together or along with the first stack 4, is enclosed by the module frame 6 of the battery module 1. The two stacks 4, 8 of the battery module 1 are thus arranged inside the module frame 6. Only some of the battery cells 5 of the second stack 8 are also provided with a reference numeral in FIG. 1. And in the second stack 8 too, the pressure exerted in the stack direction 7 of the battery cells 5 of the second stack 8 is applied to the battery cells 5 by the module frame 6.

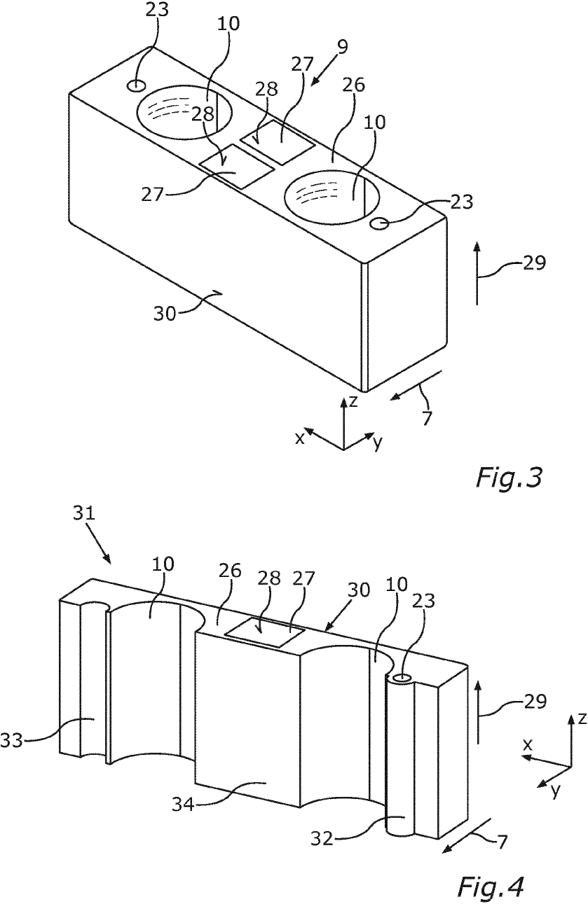

A pressure plate 9, which is shown in perspective in FIG. 3 in an exemplary embodiment, is arranged in an intermediate space between the two stacks 4, 8 and in particular, as shown in the present case by way of example, centrally between the two stacks 4, 8.

The pressure plate 9 has two passage openings 10 in the present case. Coolant lines 11, 12 of a cooling device 13 of the battery 2, which are illustrated schematically in FIG. 2, can be routed through these passage openings 10. For the sake of clarity, the battery module 1 is illustrated in FIG. 2 purely schematically as a cuboid and not with the details which can be seen in FIG. 1.

The first coolant line 11 takes the form, for example, of a coolant inflow for a cooling plate 14 through which coolant can flow. The second coolant line 12 shown in FIG. 2 then takes the form of a coolant outflow of the cooling plate 14.

When the battery cells 5 of the battery module 1 are in thermally conductive contact with the cooling plate 12, the coolant lines 11, 12 which pass through the passage openings 10 of the pressure plate 9 are arranged in the pressure plate so that they are protected from damage. The pressure exerted on the pressure plate 9 and on the battery cells 5 in the stack direction 7 thus does not act on the coolant lines 11, 12.

The pressure plate 9 in the form of a plate-like or cuboid component in the present case has a smaller extent in the stack direction 7 than in the vertical direction 29 and perpendicular to a plane defined by the stack direction 7 and the vertical direction 29.

According to FIG. 1, the module frame 6 of the battery module 1 comprises a first end plate 15 arranged at a front side of the battery module 1 and a second end plate 16 situated opposite the first end plate 15 in the stack direction 7. The end plates 15, 16 are connected to each other via side walls 17, 18 of the module frame 6, in particular by welding the side walls 17, 18 to the respective end plates 15, 16. The side walls 17, 18 thus act as tie rods which apply a pressure exerted in the stack direction 7 to the battery cells 5 of the two stacks 4, 8 and the pressure plate 9.

In the situation in which the battery 2 is installed in the motor vehicle 3, the stack direction 7 and hence the direction of the longitudinal extent of the battery module 1 extend in particular parallel to the transverse axis y of the vehicle. It can consequently be achieved that the pressure plate 9 is arranged essentially centrally in the motor vehicle 3 in the direction of the transverse axis y of the vehicle. The coolant lines 11, 12 which are routed through the passage openings 10 of the pressure plate 9 are consequently then particularly well protected from damage in the direction of the transverse axis y of the vehicle.

A plurality of the battery modules 1 shown in FIG. 1 can be arranged next to one another and connected to one another in an electrically conductive fashion in the direction of the longitudinal axis x of the vehicle in order to form the battery of the motor vehicle 3 (cf FIG. 6).

In particular a high-voltage storage device can be supplied by the battery 2 of the motor vehicle 3 because the battery modules 1 are connected to one another in an electrically conductive fashion. Such a high-voltage storage device has a rated voltage of more than 60 volts and in particular up to several 100 volts. Accordingly, the battery 2 can supply electrical energy for a drive device, for example in the form of at least one electric motor 19 of the motor vehicle 3 (cf FIG. 6). The at least one electric motor 19 can drive wheels 20 of the motor vehicle 3 and hence ensure the movement of the motor vehicle 3.

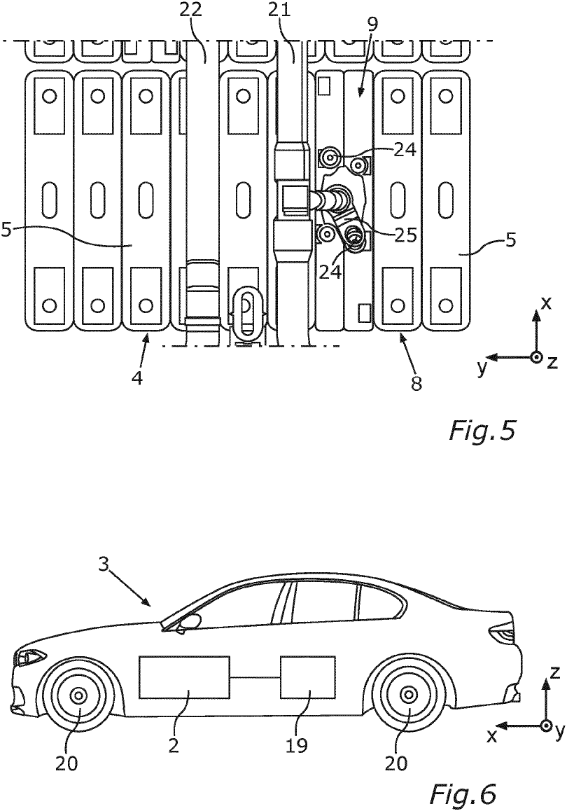

The cooling plate 14 arranged below the respective stack 4, 8 in the direction of the vertical axis z of the vehicle on battery cells 5 (cf FIG. 2) is supplied with the coolant via one of the coolant lines 11, 12. Further coolant lines 21, 22 arranged above the battery cells 5 of the battery module 1 in the direction of the vertical axis z of the vehicle (cf FIG. 5) and to which the coolant lines 11, 12 of the respective battery module 1 are connected extend in the present case in the direction of the longitudinal axis x of the vehicle and feed the coolant to and from a radiator (not shown) of the motor vehicle 3.

It can furthermore be seen in the perspective view shown in FIG. 3 of a possible variant of the pressure plate 9 that the pressure plate 9 can have threaded holes 23. Threaded bolts 24 can be screwed into such threaded holes 23 (cf FIG. 5). Retaining devices of the battery 2 can be fixed to the pressure plate 9 by way of such threaded bolts 24.

A retaining device 25 can, for example, be fixed to the pressure plate 9 by way of such a threaded bolt 24 which engages in the thread of one of the threaded holes 23 formed by injection molding in the pressure plate 9. For example, the coolant lines 21, 22 can be fixed in the region of the pressure plate 9 via such retaining device 25 (cf FIG. 5).

However, the pressure plate 9 also enables the fixing of further components or further interfaces of the battery 2 in the region of the pressure plate 9. For example, according to FIG. 3, inserts 27 which are formed from metal, can be embedded in a base body 26, formed from plastic, of the pressure plate 9. And metal components of the battery 2 can be fixed to a surface 28 of the respective insert 27 by welding.

For example, metal components of a cell contact system can be welded to one of the inserts 27. Such a cell contact system ensures that the battery cells 5 of the battery module 1 are connected to one another in an electrically conductive fashion.

A high-voltage connector and/or a bracket for the high-voltage storage device can furthermore be connected to one of the inserts 27 by welding. Such a high-voltage storage device can produce an electrically conductive connection between the respective battery modules 1 of the battery 2 and hence take the form of a module connector.

If the pressure plate 9 shown by way of example in FIG. 3 is produced in a plastic injection-molding process, the direction in which the pressure plate 9 is removed from an injection mold (not shown) can, for example, extend in the vertical direction 29 of the pressure plate 9 which, in the installed position of the battery module 1 in the motor vehicle 3, is preferably oriented parallel to the vertical axis z of the vehicle.

However, this means that bearing regions 30 or bearing surfaces of the pressure plate 9, in which the pressure plates 9 are in contact with the first stack 4 or with the second stack 8, need to be formed so that they are slightly beveled in order to enable simple removal of the pressure plate 9 from the injection mold. Accordingly, the respective bearing region 30 is then at least slightly inclined with respect to the vertical direction 29.

With regard to a uniform application of pressure to the pressure plate 9 which is in contact with the battery cells 5, which in each case adjoin the bearing regions 30, of the first stack 4 on one side and of the second stack on the other side, it is however advantageous that the bearing regions 30 are formed as flat as possible and that the bearing regions 30 are oriented so that they are perpendicular to the stack direction 7.

Therefore, when the pressure plate 9 is formed as a plastic injection-molded part, a variant can in particular be obtained which will be explained with the aid of FIG. 4. Accordingly, the pressure plate 9 comprises two plate parts 31 which are formed as structurally identical parts and one of which is illustrated schematically in FIG. 4 in a perspective view. Two of the plate parts 31 shown in FIG. 4 can be coupled to each other. The pressure plate 9 is then supplied by the two plate parts 31 when the two plate parts 31 are coupled to each other.

In the embodiment, shown by way of example in FIG. 4, of one of the plate parts 31, a part of the respective passage openings 10 of the pressure plate 9, namely in the present case a respective half of the respective passage opening 10, is supplied by one of the respective plate parts 31. Furthermore, in each of the plate parts 31, one of the two inserts 27 is embedded in the base body 26, formed from plastic, of the respective plate part 31.

Furthermore, it can be seen from FIG. 4 that the plate parts 31 can have mutually corresponding positive-locking elements which enable the plate parts 31 to be coupled to each other to supply the pressure plate 9. For example, a snap connection or a latching connection can be implemented in which the positive-locking elements are brought into engagement with one another in order to form the pressure plate 9.

In the variant, shown by way of example in FIG. 4, of the plate part 31, one of the positive-locking elements takes the form of a convex bulge 32 and one of the threaded holes 23 is formed in the region of this convex bulge 23. The positive-locking element which corresponds with this convex bulge 32 is, in the variant of the plate part 31 shown in FIG. 4, supplied by a concave recess 33 which is formed in the region of the second threaded hole 23 of the pressure plate 9 (cf FIG. 3).

The plate parts 31 can be held together to supply the pressure plate 9 by introducing the bulge 32 into the corresponding recess 33 of the other of the two plate parts 31. It can be provided here that the respective bulge 32 is introduced into the corresponding recess 33 perpendicular to the vertical direction 29. Additionally or alternatively, it can be provided that the bulge 32 is pushed into the respective recess 33 in the vertical direction 29.

Supplying the pressure plate 9 using the two plate parts 31 in the manner illustrated with the aid of FIG. 4 ensures a particularly simple implementation of the manufacture of the plate parts 31 by injection molding. This is because, for example, a sprue region or a gating point can be formed in a central region 34 of the plate part 31, and to be precise on a side, situated opposite the bearing region 30, of the plate part 31.

Accordingly, it is possible for the plate part 31 to be removed from the injection mold (not shown) perpendicular to the bearing region 30 or this flat outer surface of the plate part 31. In this way, a particularly flat design of the bearing region 30 of the respective plate part 31 and an orientation of the bearing region 30 perpendicular to the stack direction 7 can be achieved particularly simply.

### List of Reference Symbols

1 battery module
2 battery
3 motor vehicle
4 stack
5 battery cell
6 module frame
7 stack direction
8 stack
9 pressure plate
10 passage opening
11 coolant line
12 coolant line
13 cooling device
14 cooling plate
15 end plate
16 end plate
17 side wall
18 side wall
19 electric motor
20 wheels
21 coolant line
22 coolant line
23 threaded hole
24 threaded bolt
25 retaining device
26 base body
27 insert
28 surface
29 vertical direction
30 bearing region
31 plate part
32 bulge
33 recess
34 central region
x longitudinal axis of the vehicle
y transverse axis of the vehicle
z vertical axis of the vehicle

1-11. (canceled)

12. A battery for a motor vehicle, the battery comprising:
a first stack of battery cells, wherein pressure is applied to the battery cells in a stack direction of the battery cells, and
a second stack of battery cells, wherein the second stack is arranged adjacent to the first stack in the stack direction, and wherein pressure is also applied to the battery cells of the second stack in the stack direction, and
a pressure plate, to which pressure is applied in the stack direction, which is arranged in an intermediate space formed between the first stack and the second stack and is formed from plastic, at least in respective bearing regions in which the pressure plate is in contact with the first stack and with the second stack.

13. The battery according to claim 12, wherein the pressure plate has at least one passage opening for routing at least one coolant line of a cooling device of the battery through the pressure plate.

14. The battery according to claim 12, wherein at least one base body, having bearing regions of the pressure plate, is formed from plastic.

15. The battery according to claim 14, wherein at least one insert, formed from metal and to a surface of which at least one metal component of the battery is fixable by welding, is introduced into the base body.

16. The battery according to claim 12, wherein the pressure plate has a first plate part and a second plate part which form the pressure plate when coupled to each other.

17. The battery according to claim 16, wherein the first plate part and the second plate part are formed with a same structure.

18. The battery according to claim 17, wherein the first plate part and the second plate part are formed as injection-molded parts.

19. The battery according to claim 16, wherein the first plate part and the second plate part have mutually corresponding positive-locking elements which engage with one another when the first plate part and the second plate part are coupled to each other.

20. The battery according to claim 12, wherein bearing regions are formed to be flat and oriented perpendicular to the stack direction.

21. The battery according to claim 12, wherein the pressure plate has at least one threaded hole into which a threaded bolt is screwable in order to fix at least one retaining device of the battery to the pressure plate.

22. The battery according to claim 12, wherein:
the first stack and the second stack are components of a battery module of the battery,
the battery module comprises a module frame, and
the module frame encloses the two stacks of the battery module and pressure is applied to the module frame.

23. The battery according to claim 22, wherein the battery comprises a plurality of battery modules which are connected to one another in an electrically conductive fashion.
